(19) United States
(12) Patent Application Publication
(10) Pub. No.: US 2026/0260876 A1
(43) Pub. Date: Sep. 3, 2026

(54) COMPOSITE CATHODE FOR ALL SOLID STATE LITHIUM BATTERIES AND METHODS THEREFOR

(71) Applicant: A123 Systems LLC, Novi, MI (US)

(72) Inventors: Srikanth Balijapelly, Waltham, MA (US); Grayson Hoteling, Newton, MA (US); David Laughman, Acton, MA (US)

(21) Appl. No.: 19/448,015

(22) Filed: Jan. 13, 2026

Related U.S. Application Data
(60) Provisional application No. 63/765,343, filed on Feb. 28, 2025.

(51) Int. Cl. H01M 4/36; H01M 4/02; H01M 4/04; H01M 4/134; H01M 4/1397; H01M 4/38; H01M 4/58; H01M 4/62; H01M 10/0525; H01M 10/0562; H01M 10/0585

(52) U.S. Cl. CPC H01M 4/366; H01M 4/0471; H01M 4/134; H01M 4/1397; H01M 4/382; H01M 4/5825; H01M 4/625; H01M 10/0525; H01M 10/0562; H01M 10/0585; H01M 2004/021; H01M 2004/027; H01M 2004/028; H01M 2300/0068

(57) ABSTRACT

Methods and systems are provided for a composite cathode of a solid state lithium ion battery. Method include coating lithium iron phosphate particles by obtaining carbon coated LFP particles, mixing the carbon coated LFP particles with an alkoxide precursor solution to form a mixture, hydrolyzing the mixture to form hydrolyzed carbon coated LFP particles, and heating the hydrolyzed carbon coated LFP particles to from an amorphous buffer coating on the carbon coated LFP particles.

### CROSS-REFERENCE TO RELATED APPLICATIONS

The present application claims priority to U.S. Provisional Application No. 63/765,343 entitled “COMPOSITE CATHODE FOR ALL SOLID STATE LITHIUM BATTERIES AND METHODS THEREFOR” filed Feb. 28, 2025. The entire contents of the above listed application is hereby incorporated by reference for all purposes.

### FIELD

The present description relates generally to a composite cathode for all solid state lithium batteries.

### BACKGROUND AND SUMMARY

All solid state lithium batteries including solid state electrolytes are desirable due, in part, to increased energy densities as well as increased safety achieved by replacing highly flammable conventional liquid electrolytes with less violently reactive solid state electrolytes. Increased energy densities are particularly attractive for all solid state batteries including inherently lower energy density cathode active materials, such as lithium iron phosphate (LFP). Low energy density cathode active material such as LFP may be desired over other high energy density alternatives due to material cost savings and thermal safety features of LFP, and the like.

Conventionally, all solid state batteries including LFP use ceramic oxide and polymer based electrolytes instead of sulfide based electrolytes due to the occurrence of side reactions between cathode active material and the sulfide based electrolyte. One example of such a side reaction is decomposition of the sulfide based solid state electrolyte at interfaces with a cathode active material leading to formation of byproducts which are both electrically and ionically insulating. Deposition of the byproducts on a surface of the cathode active material therefore results in increased cell impedance and decreased battery performance over time.

The inventors herein have identified the above problems and have determined solutions to at least partially address the problems. As one example, a method of coating lithium iron phosphate (LFP) for an all solid state lithium ion battery comprises: obtaining carbon coated LFP particles, mixing the carbon coated LFP particles with an alkoxide precursor solution to form a mixture, hydrolyzing the mixture to form hydrolyzed carbon coated LFP particles, and heating the hydrolyzed carbon coated LFP particles to form an amorphous buffer coating on the carbon coated LFP particles.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic diagram of a solid state lithium ion battery including a buffer and conductive coated low energy density cathode material.

FIG. 2 shows a method of forming the buffer and conductive coated low energy density cathode material of FIG. 1.

FIG. 3 shows SEM images of low energy density coated cathode material before and after buffer coating as described in FIG. 2.

FIG. 4 shows an illustration of a cross section of the conductive and buffer coated low energy density cathode material.

FIG. 5 shows a graph of size distribution of low energy density cathode materials before and after buffer coating according to the method of FIG. 2.

FIG. 6 shows a graph of size distribution of a slurry including the low energy density cathode material before and after buffer coating according to the method of FIG. 2.

FIG. 7 shows a graph of resistance as a function of electrode porosity for electrodes prepared with conductive coated low energy density cathode materials and with conductive and buffer coated low energy density cathode materials.

FIGS. 8 and 9 each show a graph of capacity as a function of cycle number at different rates for all solid state lithium ion batteries prepared with conductive coated low energy density cathode materials and with conductive and buffer coated low energy density cathode materials.

FIG. 10 shows a chart of coulombic efficiency for all solid state lithium ion batteries prepared with conductive coated low energy density cathode materials and with buffer and conductive coated low energy density cathode materials.

FIG. 11 shows graphs of resistance as a function of cycle number for all solid state lithium ion batteries prepared with conductive low energy density cathode materials and with conductive and buffer coated low energy density cathode materials.

### DETAILED DESCRIPTION

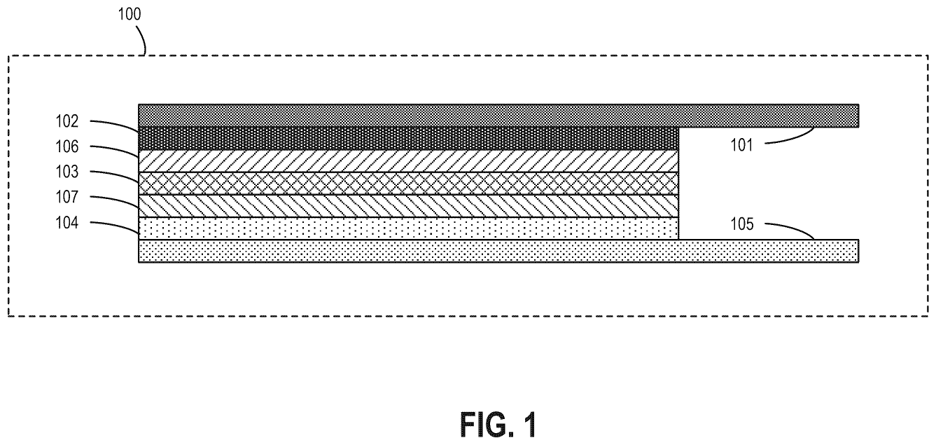

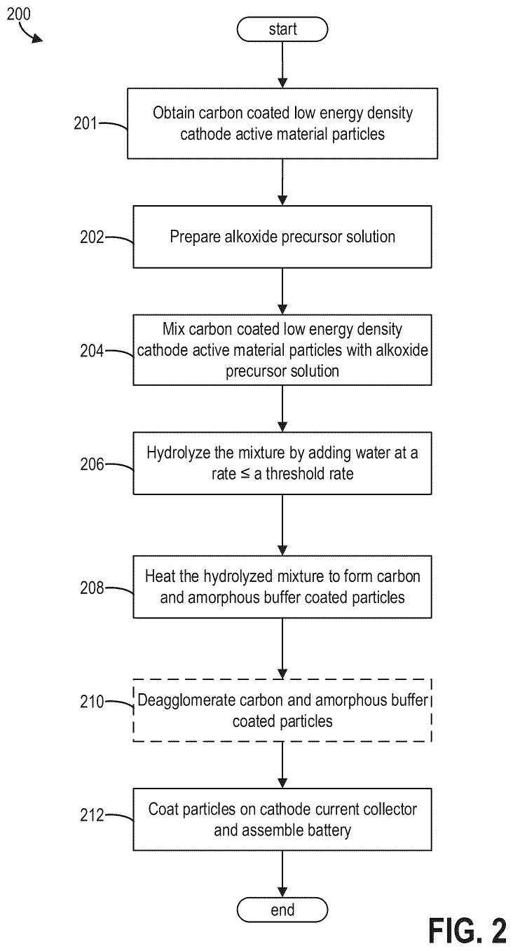

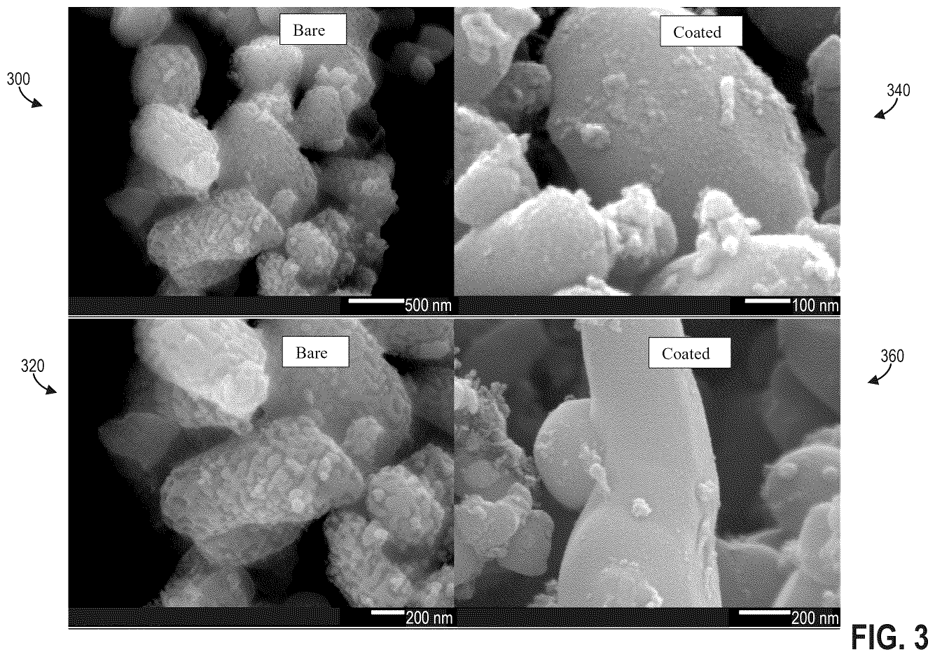

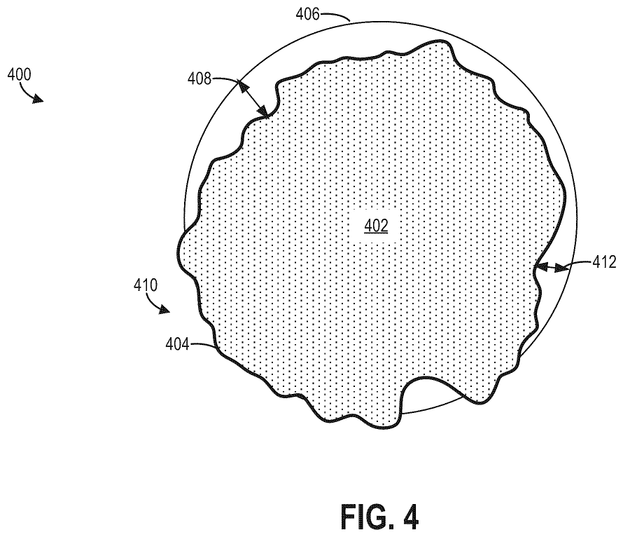

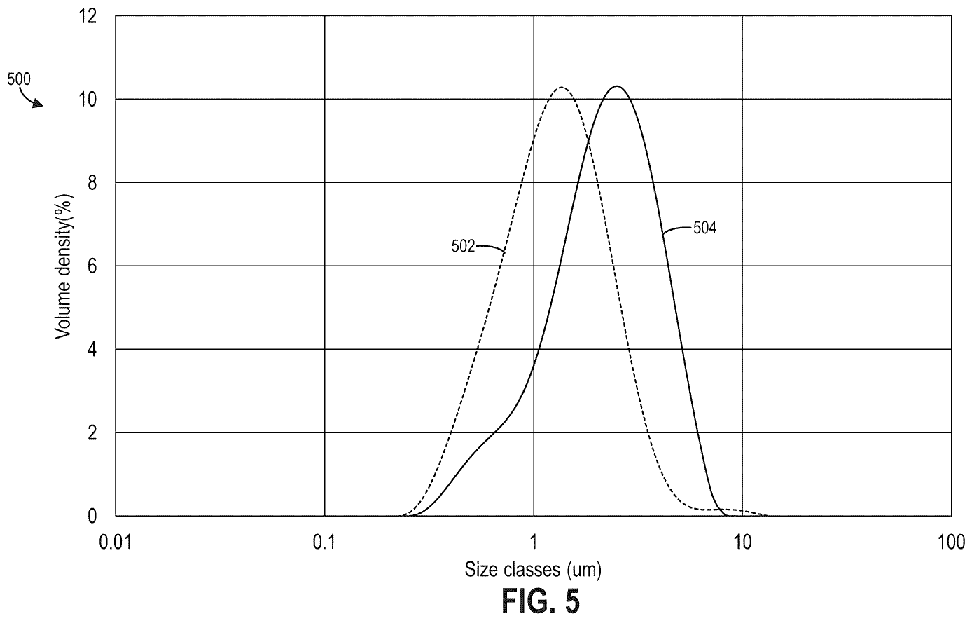

The following description relates to composite cathodes for all solid state lithium ion batteries. Herein, all solid lithium ion batteries are lithium ion batteries including solid state electrolytes, such as the all solid state lithium ion battery shown in FIG. 1. The composite cathode of the all solid state lithium ion batteries may include coated cathode materials wherein the core is a low energy density cathode material. Lithium iron phosphate (LFP, LiFePO₄) is provided herein as a non-limiting example of a low energy density cathode material. A low energy density cathode material may have an energy density less than 200 Wh/Kg in a liquid electrolyte. For example, a low energy density cathode material, such as LFP, may have an energy density in a liquid electrolyte cell in a range of 150 to 200 Wh/Kg, which is 40% lower than a high energy density NCM 811 (LiNi_{0.8}Mn_{0.1}Co_{0.1}O₂) based chemistries. A method for coating a low energy density cathode material with a lithium metal oxide coating is shown in FIG. 2. In a non-limiting example, the lithium metal oxide coating is amorphous LiNbO₃. SEM images of LFP before and after coating with amorphous LiNbO₃ are shown in FIG. 3. A cross section of the core particle and coating is shown in FIG. 4. Using the example of carbon coated LFP compared to amorphous LiNbO₃ and carbon coated LFP, sizes, slurries, and performance of all solid state lithium ion batteries, changes in the resistance, cyclability and performance of the resulting all solid state lithium ion batteries may be compared in FIGS. 5-11.

Referring now to FIG. 1, an illustration of a non-limiting example of a solid state lithium ion battery cell sub-assembly (e.g., the battery cell) 100, is depicted. Sequentially, the battery cell 100 may include an anode current collector 101, an anode material layer 102, an anode separator interfacial layer 106, a separator layer 103, a cathode separator interfacial layer 107, a cathode material layer 104, and a cathode current collector 105. As such, the separator layer 103 may function as a battery separator. In some examples of the solid state lithium ion battery cell sub-assembly 100, anode separator interfacial layer 106 and/or cathode separator interfacial layer 107 may be omitted. In further examples, multiple cathode separator interfacial coatings and/or anode separator interfacial coatings may be included.

One or more of the anode material layer 102 and the anode separator interfacial layer 106 may include an anode active material which contains lithium. One or more of the cathode material layer 104 and the cathode separator interfacial layer 107 may include a cathode active material which contains lithium.

The cathode material layer 104 may include low energy density cathode active material particles. The low energy density cathode active material particles may include a conductive coating and a buffer coating. The buffer coating may be ionically conductive and electrically insulating. Further, the buffer coating may be amorphous. The buffer coating may be a lithium metal oxide, lithium metal halide, or a metal oxide. For example, the metal oxide may be one or more of Al₂O₃ and ZrO₂. For example, the lithium metal oxide may be one or more of Li₃BO₃, Li₃PO₄, Li₄SiO₄, LiAlO₂, Li₄Ti₅O₁₂, LiTaO₃, LiNbₓTa₁₋ₓO₃, and LiNbO₃. In some examples, the buffer coating may be one or more of Li₃InCl₆, Li₃YCl₆, and Li₃MBr₆ (M=Y, Sc, Ho). In some examples, the buffer layer may be amorphous LiNbO₃. The low energy density cathode material may be one or more of LFP, lithium cobalt oxide, lithium nickel cobalt aluminum oxide (NCA), lithium manganese iron phosphate (LFMP), and lithium manganese nickel oxide (LMNO). In some examples, the low energy density cathode material may include a conductive coating interposed between the low energy density cathode material and the buffer coating. The conductive coating may be formed of carbon.

One or more of the anode material layer 102, the anode separator interfacial layer 106, the separator layer 103, the cathode separator interfacial layer 107, and the cathode material layer 104 may additionally include a sulfide based electrolyte and polymer binder. The polymer binder may be electrically and ionically insulating. The sulfide based electrolyte may be one or more of, but not limited to, Li₆PS₅Cl, Li₇P₃S₁₁, Li₅PS₄ClBr, and Li₃PS₄. A cathode sulfide based electrolyte may be included in the cathode material layer 104 and cathode separator interfacial layer 107. An anode sulfide based electrolyte may be included in the anode material layer 102 and the anode separator interfacial layer 106. A separator sulfide based electrolyte may be included in the separator layer 103. In one example, the cathode sulfide based electrolyte, anode sulfide based electrolyte, and separator sulfide based electrolyte may be formed of the same material.

In some examples, an adhesion interface may be defined between the separator layer 103 and an electrode structure. The adhesion interface may be a three-dimensional interface between the separator layer 103 and the electrode structure, such that the separator layer 103 may conform to, and permeate into, a surface of the electrode structure. As a first example, the electrode structure may be the anode material layer 102 deposited on the anode current collector 101, optionally with the anode separator interfacial layer 106 deposited thereon. As a second example, the electrode structure may be the cathode material layer 104 deposited on the cathode current collector 105, optionally with the cathode separator interfacial layer 107 deposited thereon.

Turning now to FIG. 2, a flowchart of an example of a method 200 for forming a conductive and buffer coated low energy density cathode material, such as the conductive and buffer coated low energy density cathode material included in the cathode material layer as described above with respect to FIG. 1 is shown. For example, method 200 may form a buffer coating on carbon coated lithium iron phosphate particles.

At 201, method 200 includes obtaining carbon coated low energy density cathode active material particles. A carbon coating may be present on a surface of the low energy density cathode material particles as a result of the conditions of the synthesis of the low energy density surface cathode material particles. The carbon coating on the low energy density cathode active material particles may be an amorphous carbon coating. The low energy density cathode active material particles may be synthesized to be carbon coated to increase electronic conductivity between the low energy density cathode active material particles.

The carbon coating may comprise 1% to 2% by weight of the low energy density cathode active material. The carbon coating may be a thickness in a range of from 1 nm to 10 nm. As one example, the low energy density cathode active material may be LFP coated with carbon. The carbon coated LFP particle may include 1 to 2% carbon by weight. Other low energy density cathode active material particles are also considered as listed above with respect to FIG. 1. The low energy density cathode active material particles may be single crystalline particles. An entire crystal structure of single crystalline particle may be an unbroken crystal structure and may not include grain boundaries. The single crystalline particles may not be polycrystalline and may not be amorphous. A D50 of the low energy density cathode active material particles may be in a range of 2 μm-4 μm. For example, a D50 of the LFP core particle may be in a range of 2 μm-4 μm.

At 202, method 200 includes preparing an alkoxide precursor solution. As one example, the alkoxide precursor solution may be a lithium metal alkoxide precursor solution. Preparing the alkoxide solution precursor may include mixing reagents in a solvent to form a lithium alkoxide and a metal alkoxide. In some examples, alkoxide precursors may be obtained separately and preparing the alkoxide precursor solution may include mixing the alkoxide precursors in a solvent. Mixing the reagents may include agitating the solvent to homogeneously disperse the reagents and/or alkoxide precursors in the solvent to form a solution. The metal of the metal alkoxide solution may be a metal which is incorporated into a buffer coating as described further below.

As a further example, the alkoxide precursor solution may be a lithium niobate precursor solution. An alkoxide precursor solution may be a solution of lithium alkoxide and metal alkoxide (e.g., niobium alkoxide) in a non-aqueous, water miscible solvent. In one example, a weight percent of the lithium niobate precursors in the lithium niobate precursor solution may be between 2% and 3%. Preparing the lithium niobate precursor may include preparing a solution of lithium metal (or lithium ethoxide) and niobium ethoxide in ethanol.

A relative molar ratio of lithium to niobium in the lithium niobate precursor solution may be tuned according to a surface chemistry of the cathode active material to be coated. For example, a surface of the low energy density cathode active material may be lithium rich or lithium deficient based on the material and method of production. The relative molar ratio may be adjusted depending on an amount of excess or an amount of deficiency of lithium in order to result in a 1:1 ratio of lithium to niobium in the resulting coating. For example, if the surface chemistry is lithium deficient, the molar ratio of lithium to niobium may be greater than 1. For example, the molar ratio of lithium to niobium may be in a range 1-1.25:1 if the surface chemistry is lithium deficient. In examples where the surface chemistry is lithium rich, the molar ratio of lithium to niobium may be less than one. For example, the molar ratio of lithium to niobium may be in a range of 0.9-1:1 if the surface chemistry is lithium rich. As a further example, the molar ratio of lithium to niobium may be in a range of 0.9-1.25:1. In this way, the lithium niobate coating may be formed with a desired 1:1 ratio of lithium to niobium. In some examples, the molar ratio of lithium to niobium may be 1.1:1.

At 204, method 200 includes mixing the carbon coated low energy density cathode active material particles with the alkoxide precursor solution. Mixing may include adding the carbon coated low energy density cathode active material particles to the alkoxide precursor solution prepared at 202 and agitating to homogeneously disperse the carbon coated low energy density cathode active material particles with the alkoxide precursor solution. Mixing may cause the alkoxide precursors to form a coating over an outer surface of the carbon coated low energy density cathode active material particles. In this way, mixing at step 204 results in coating the carbon coated low energy density cathode active material particles with alkoxide precursors.

Mixing may include mixing the low energy density cathode active material particles and alkoxide precursor solution for a period of time at room temperature. For example, the period of time may be in a range between 1 minute and 10 minutes. A mixing speed may be in range of 150 rpm to 2000 rpm. In this way, the alkoxide precursors may attach to the surface of the low energy density cathode active material particles.

A weight percent of the buffer material (e.g., LiNbO₃) in a buffer coated low energy density cathode active material particle may determine a thickness of the buffer coating formed by method 200. A coating (e.g., buffer coating) which is too thin may not effectively prevent side reactions between the low energy density cathode active material and the electrolyte. A coating which is too thick may not effectively allow lithium ions or electrons to move through the coating when a battery including the cathode active material particles is charging and/or discharging.

In one example, the low energy density cathode active material particle may include areas which are not covered by the amorphous buffer layer coating. In the not covered areas, a native carbon coating on a surface of the low energy density cathode active material particle may be exposed. Not covered areas may include the carbon coating to help with electron transfer between the low energy density cathode active material particles and between the low energy density cathode active material and conductive additives in the cathode layer. In one example, a weight percent of LiNbO₃ in the coated particles is between 0.1% and 3%. In alternate examples, the weight percent of LiNbO₃ in the coated particles is between 0.5% and 3%. In still further examples, the weight percent of LiNbO₃ in the coated particle is 1%.

At 206, method 200 includes hydrolyzing the mixture of alkoxide precursor attached to carbon coated low energy density cathode active material particles by adding water at a rate less than or equal to a threshold rate. Hydrolyzing may form hydrolyzed carbon coated low energy density cathode active material particles. For example, hydrolyzing may form hydrolyzed carbon coated LFP particles. Adding water at a rate less than or equal to a threshold rate may result in the hydrolyzed solution remaining transparent (e.g., not cloudy or turbid). Turbidity may occur due to a presence of excess of water driving condensation of the alkoxide precursors instead of the desired hydrolysis reaction. When condensation occurs before hydrolysis, hydrolysis is incomplete and the coating formed may not be molecularly homogeneous. For this reason, hydrolyzing the mixture of alkoxide precursor attached to the low energy density cathode active materials includes adding water below the threshold rate. Adding water at or below the threshold rate may favor hydrolysis of the lithium niobate precursors over condensation of the lithium niobate precursors.

In one example, hydrolysis may be completed by adding 4-12 moles of water per one mole of niobium in the mixture. In an alternate example, hydrolysis may be completed by adding 5-10 moles of water per one mole of alkoxide in the mixture. Addition of water faster than the threshold rate may result in an undesirable turbid solution. In one example, the threshold rate may be less than or equal to 5 mL/min added as a solution of 2-10 vol. % water in the non-aqueous solvent. In some examples, the solution may be a 5 vol % solution of water in the non-aqueous solvent. Additionally or alternatively, the threshold rate may be 0.1 mL of water per minute. Slowly adding water may ensure full hydrolysis of the alkoxide precursors to ultimately form the uniform coating (e.g., coating of lithium niobate). After adding the total amount of water, the mixture may be stirred for less than or equal to 5 minutes at room temperature. At the end of 5 minutes, hydrolysis of the alkoxide precursor may be finished.

At 208, method 200 includes heating the hydrolyzed mixture to form carbon and amorphous buffer coated particles. The carbon and amorphous buffer coated particles may include a carbon coating and an amorphous buffer coating. Heating may include adding thermal energy to both remove solvent from the hydrolyzed mixture and to from an amorphous buffer coating from the hydrolyzed alkoxide precursors. The heating temperature may be a temperature which is high enough to complete the conversion of the alkoxide precursors to the desired amorphous oxide buffer layer, but low enough the avoid crystallization and undesired degradation due to oxidation. In some examples the amorphous buffer is an amorphous lithium metal oxide. In examples where the coating is LiNbO₃, the heating may include heating under O₂ atmosphere at a temperature at or below 250° C. Heating LFP above 250° C. in an O₂ atmosphere may cause degradation of the LFP via surface oxidation. Unexpectedly, heating at a temperature at or below 250° C. is still leads to a buffer coating surrounding the low energy density cathode material particles.

In some examples, heating may include first removing solvent at lower temperatures under vacuum (e.g., via rotary evaporator at 65° C.), before heating the dried particles under O₂ atmosphere. The lower temperature may be a temperature below a boiling point of the solvent, thus demanding vacuum to dry in timely manner. In this way, crystallinity of the LiNbO₃ coating may be minimized as well as minimizing an amount of residual carbon. Additionally, electrical properties of the LiNbO₃ coating for a low energy density cathode active material may be enhanced (e.g., increased ionic conductivity and decreased electrical conductivity) by the heating. After heating, the low energy density cathode active material particles may include a uniform amorphous buffer layer coating. Further, heating in this way may preserve the carbon coating deposited on the low energy density cathode active material particles at step 201. For example, the heating process at the selected temperatures may prevent the carbon coating from dispersing or diffusing into the buffer layer coating. In this way the selected heating steps and temperatures may preserve discrete layers of carbon coating and buffer layer coating which are beneficial to the electrical properties of the cathode as described further below. For example, the buffer coating may be LiNbO₃.

At 210, method 200 optionally includes deagglomerating the carbon and amorphous buffer layer coated low energy density cathode active material particles. Non-mechanically rigid agglomerates may form after heating. In one example, deagglomerating may include sieving the coated particles through a 40 μm mesh. In alternate examples, air jet milling or other deagglomeration techniques may be used.

At 212, method 200 includes coating the carbon and amorphous buffer coated particles onto a cathode current collector and assembling a battery. In one example, coating the deagglomerated particles may include dispersing the coated cathode active material particles in a slurry including solid state electrolyte and depositing the slurry to form a cathode material layer, such as cathode material layer 104 of FIG. 1. The slurry may further include one or more of solvent, binder, carbon additives, among other known components of solid state lithium ion battery slurries as listed above with respect to FIG. 1.

As one example, the cathode material coating may include carbon and buffer layer coated low energy density cathode active material particles (e.g., cathode active coating) in a range of from 60 wt. % to 85 wt. %. In further examples, the cathode active coating may be included in a range of from 65 wt. % to 75 wt. %. In some examples, the cathode active coating may be included at approximately (e.g., with +/−5%) 70 wt. %. Sulfide electrolyte may be included in the cathode material coating in a range of 12 wt. % to 30 wt. % In further examples, sulfide electrolyte may be included in a range of from 20 wt. % to 30 wt. %. In some examples, the sulfide electrolyte may be included at approximately 25 wt. %. Binder may be included in the cathode material coating in a range of from 1.5 wt. % to 5 wt. %. In some examples, the binder may be included in a range of 1.5 wt. % to 3.5 wt. %. In one example, the binder may be included at approximately 2.5 wt. % binder. Conductive carbon may be included in the cathode material coating in a range of from 1.5 wt. % to 5 wt. %. In some examples, the conductive carbon may be included in a range of from 1.5 wt. % to 3.5 wt. %. In one example, conductive carbon may be included at approximately 2.5 wt. %. The solid state electrolyte used in the coating may be a cathode sulfide based solid state electrolyte. The cathode material coating may be further assembled into a battery such as the battery cell 100 of FIG. 1. For example, the solid state lithium ion battery may include a lithium metal based anode. Method 200 ends.

Turning now to FIG. 3, SEM images of examples of conductive carbon coated and conductive carbon and buffer coated low energy density cathode active material particles are shown. A first SEM image 300 and a second SEM image 320 each show examples of conductive carbon coated (e.g., without a buffer coating) single crystalline lithium iron phosphate particles. A surface of the conductive carbon coated single crystalline LFP particles shown in first SEM image 300 and second SEM image 320 may include textured features due to agglomeration of secondary particles to form the primary LFP particles. A third SEM image 340 and fourth SEM image 360 show examples of the LFP particles of first SEM image 300 and second SEM image 320 coated with LiNbO₃ as described above with respect to method 200. Compared to the bare LFP particles, the buffer coated LFP particles shown in third SEM image 340 and fourth SEM image 360 are visibly smoother and do not include the textured features of the bare LFP particles. In this way, the buffer coating may conform to surface features of the carbon coated LFP particles forming a conformal coating as described further below with respect to FIG. 4.

Turning now to FIG. 4, an illustration of a cross section of a buffer coated low energy density cathode active material particle 400 is shown. Low energy density cathode active material core 402 may be an example of a single crystalline core. In some examples, low energy density cathode active material core may be an LFP core, or in further examples a single crystalline LFP core. A surface of the low energy density cathode active material core may include an electrically conductive coating 404. As one example, conductive coating 404 may be formed of carbon. A thickness of conductive coating 404 may be in a range of from 1 nm to 10 nm. Further, conductive coating may comprise 0.9% to 1.4% of the total weight of coated low energy density cathode active material particle without buffer coating 406. The conductive coating 404 may be thick enough to increase electronic conductivity of the low energy density cathode active material. Low energy density cathode active material core 402 may be at least partially coated by buffer coating 406. As one example, buffer coating 406 may be amorphous LiNbO₃. Conductive coating 404 may be positioned between buffer coating 406 and low energy density cathode active material core 402. Conductive coating 404 may be an example of the carbon coating as described above with respect to FIG. 2. Conductive coating 404 may be in face sharing contact with both buffer coating 406 and low energy density cathode active material core 402. The conductive coating 404 may remain intact during the heating process to form buffer coating 406 due to the low temperatures used for heating. In contrast heating at a higher temperature, for example a temperature to form crystalline LiNbO₃, may result in decomposition of conductive coating 404 and/or diffusion of the conductive coating 404 into the buffer coating 406.

A thickness 408 of the buffer coating 406 may be in a range between 5 nm and 60 nm. As one example, a maximum thickness of the buffer coating 406 may be 60 nm. Buffer coating 406 may conform to a textured surface of low energy density cathode active material core 402 making the outer surface of the portions covered by buffer coating 406 smoother. Combined, buffer coating 406 and conductive coating 404 may have a thickness 412 in a range of from 5 nm to 100 nm. In an alternate example, the thickness 412 may be in a range of from 5 nm to 50 nm. Further, the combined buffer coating 406 and conductive coating 404 may comprise between 0.5 wt % and 5 wt % of the coated low energy density cathode active material particle 400. In an alternate example, combined buffer coating 406 and conductive coating 404 may comprise between 0.5 wt. % and 3 wt. %.

It is an unexpected result that covering at least a portion of conductive coating 404 with buffer coating 406, which is electrically insulating, results in cathode active materials that still readily exchange lithium with the surrounding ionically conductive electrolyte. Surface coverage of buffer coating 406 on low energy density cathode active material core may be less than 100%. For example, buffer coating 406 may cover between 85% to 95% of the surface of low energy density cathode active material core 402. The coated low energy density cathode active material particle 400 may further include unbuffered areas 410 which include conductive coating 404 but may not include buffer coating 406. For example, the conductive coating 404 in unbuffered areas 410 may not be in face sharing contact with the buffer coating 406. Additionally, the conductive coating in the unbuffered areas 410 may be in direct contact with a neighboring coated low energy density cathode active material particle and/or with the solid-state electrolyte. Unbuffered areas 410 may provide a more conductive interface between neighboring coated low energy density cathode active material particles 400 in a cathode of an all solid state lithium ion battery. In one example, unbuffered area 410 may be a non-zero percentage of the surface area of coated low energy density cathode active material. In this way, direct contact between the low energy density cathode active material (e.g., LFP) and solid electrolyte may be minimized without compromising percolation between the low energy density cathode active material particles.

Turning now to FIG. 5, a graph 500 of size distributions of bare LFP with a carbon coating (also referred to as bare LFP) and LFP coated with carbon and with 1 wt. % LiNbO₃ is shown. Images of the particles measured for graph 500 are shown in FIG. 3 described above. A first plot 502 corresponds to a size distribution of the bare particles. A second plot 504 corresponds to a size distribution of the particles coated with 1 wt. % LiNbO₃. Table 1 below shows the average sizes determined from the size distribution data shown in graph 500.

TABLE 1
Particle size distributions of bare LFP
and LFP coated with 1 wt. % LiNbO₃

| | Dx (10) (μm) | Dx (50) (μm) | Dx (90) (μm) |
|---|---|---|---|
| Bare | 0.572 | 1.27 | 2.61 |
| Coated | 0.872 | 2.23 | 4.39 |

As shown by graph 500 and Table 1, a small increase in average particle size is measured when comparing bare and coated LFP particles. In comparison, the SEM images of the same particles shown in FIG. 3 indicate a thin coating which does not significantly increase a diameter of the particle. Without being bound by theory, the measured increase in average particle size may be due to agglomerates of coated particles formed during the heating process which forms the LiNbO₃ coating.

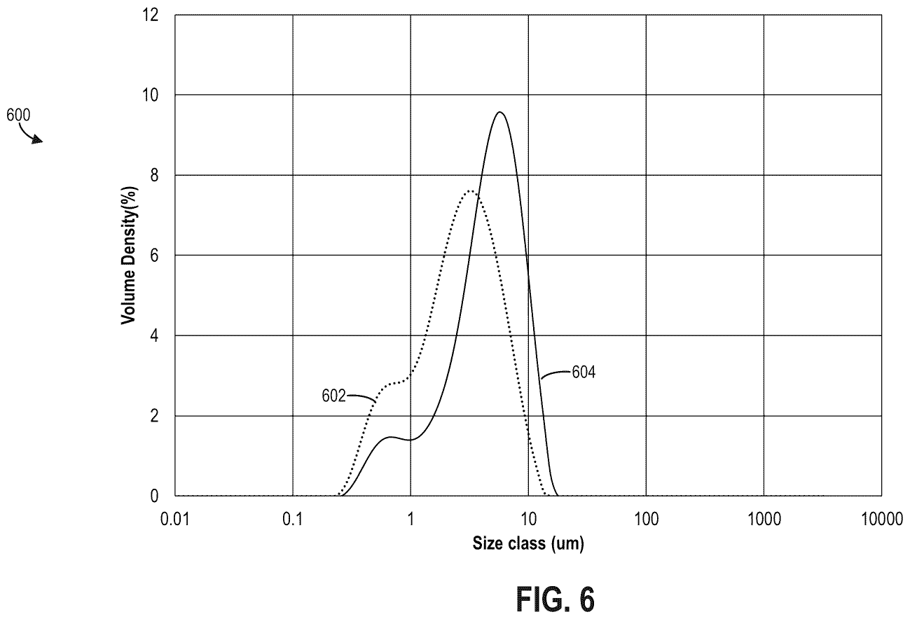

Turning now to FIG. 6, a graph 600 of particle size distribution of a slurry used to form a cathode active material coating of an all solid state lithium ion battery is shown. The slurry may include the cathode active material particles as well as binder, electrolyte, conductive carbon and solvent. As one example, a weight percent of the solid components may be 70 wt. % cathode active material particles, 25 wt. % sulfide electrolyte, and 2.5 wt. % conductive carbon. A first plot 602 corresponds to slurry formed where the cathode active material particles are the bare LFP and a second curve 604 corresponds to the slurry formed where the cathode active material particles are the LFP coated with 1 wt. % LiNbO₃. As shown in graph 600, the larger agglomerates of the coated LFP cathode active material particles are maintained during slurry formation. It is unexpected that a cathode active material coating including the agglomerated coated LFP particles may still result in cathode layer with a higher performance (such as capacity and charge transfer resistance) than bare cathode active material particles without agglomerates, as the agglomerates may cause slower lithium diffusion through the bulk LFP phase of the particles. As described further below, the buffer coating may have enough of a positive effect on charge transfer kinetics and the cathode/electrolyte interface to overcome the formation of agglomerates.

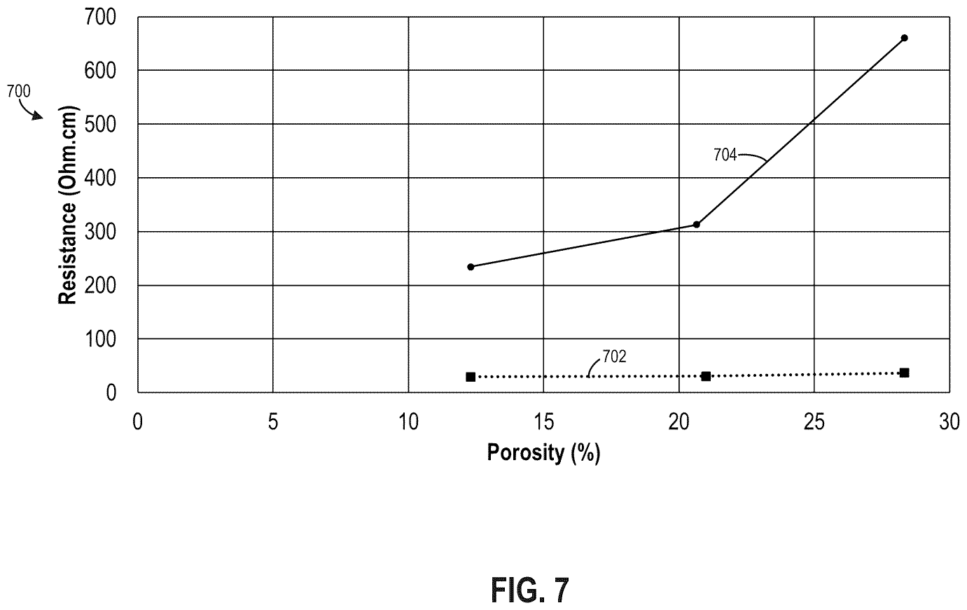

Turning now to FIG. 7, the slurries described and analyzed in FIG. 6 may be used to form cathodes of an all solid state lithium ion battery (SS-LIB) as described above with respect to FIG. 1. A graph 700 shows dry resistance as a function of electrode porosity. Porosity of the electrode may be adjusted be adjusted during calendering of the cathodes. Adjusting a gap setting of calendering rollers may be used to control porosity of the electrode (e.g., degree of densification). For example, decreasing a size of the gap may decrease porosity and increasing a size of the gap may increase porosity. A first plot 702 corresponds to electrodes prepared using the bare LFP slurry as described above with respect to FIG. 6. A second plot 704 corresponds to electrodes prepared using the LFP particles coated with 1 wt. % LiNbO₃. As shown in FIG. 7, addition of the electrically insulating LiNbO₃ coating causes an increase in resistance of the electrode. As described further below, the increase in resistivity may be balanced by buffering afforded to side reactions between the LFP and sulfide based electrolyte, thereby resulting in an overall benefit to the performance of the SS-LIB formed using the buffer layer coated low energy density particles. A buffer coating thickness and coverage may be selected in a range which balances the increased resistivity with the buffering of side reactions.

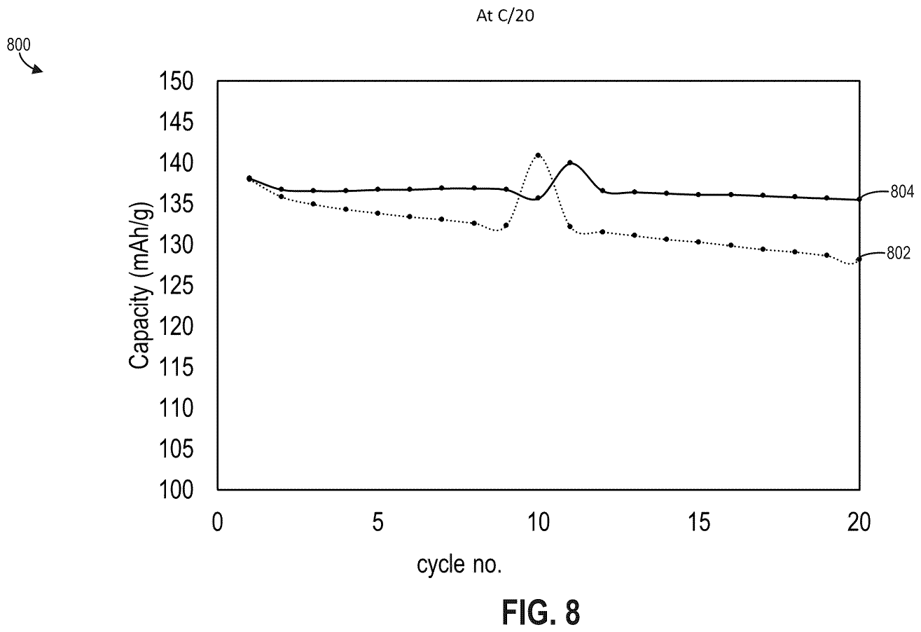

The cathode material layer electrodes prepared and measured in FIG. 7 are each further incorporated into an SS-LIB to from an SS-LIB including the bare carbon coated LFP cathode active material (bare SS-LIB) and a corresponding SS-LIB including the LFP coated carbon and with 1 wt. % LiNbO₃ (coated SS-LIB). Each of the bare SS-LIB and coated SS-LIB include a lithium metal-based anode. The coated SS-LIB and bare SS-LIB are the same except for the addition of the 1 wt. % LiNbO₃ coating in coated SS-LIB. FIGS. 8-11 show results measured from cycling (e.g., charging and discharging) both the bare SS-LIB and coated SS-LIB at 70° C. using a stack pressure in a range of 0.5 MPa-2 MPa.

Turning now to FIG. 8, a graph 800 is shown of capacity as a function of cycle number for cycling the bare SS-LIB and the coated SS-LIB at a rate of C/20. A first plot 802 corresponds to the bare SS-LIB and a second plot 804 corresponds to the coated SS-LIB. As shown in FIG. 8, for a first charging/discharging cycle a capacity of the bare SS-LIB and coated SS-LIB are similar. As the batteries undergo further charging/discharging cycles, a capacity fade of the bare SS-LIB is faster than a capacity fade of the coated SS-LIB. The spike in capacity measured at cycles 10 and 11 for each of bare SS-LIB and coated SS-LIB, respectively is due to a capacity check performed at a rate of C/40 and is used to determine a state of health (SOH) of the battery. The check performed during the cycle shown in graph 800 determined a similar SOH for the bare SS-LIB and the coated SS-LIB, indicating the coated SS-LIB both maintains sufficient conductive contact with the surrounding electrolyte to maintain capacity and suppresses side reactions. Further, the coated SS-LIB shows increased rate capability on behalf of the larger specific capacity accessed by reducing the cycling rate compared to the bare SS-LIB.

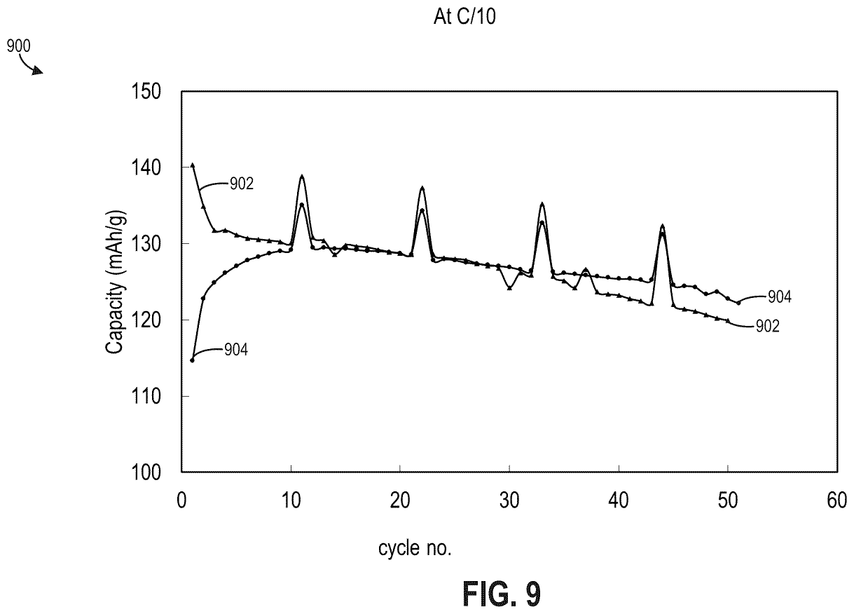

Turning now to FIG. 9, a graph 900 is shown of capacity as a function of cycle number for cycling the bare SS-LIB and the coated SS-LIB at a rate of C/10. A first plot 902 corresponds to the bare SS-LIB and a second plot 904 corresponds to the coated SS-LIB. As shown in graph 900, when the charging rate is increased the capacity of the first few cycles of the coated SS-LIB are lower than the capacity of the bare SS-LIB. However, after 50 cycles the capacity of the coated SS-LIB is higher than that of the bare SS-LIB. Without being limited by theory, the lower first cycle capacity of the coated SS-LIB may be due to clustering of the coated LFP particles which rearrange upon cycling, thereby facilitating increased access to the cathode active material.

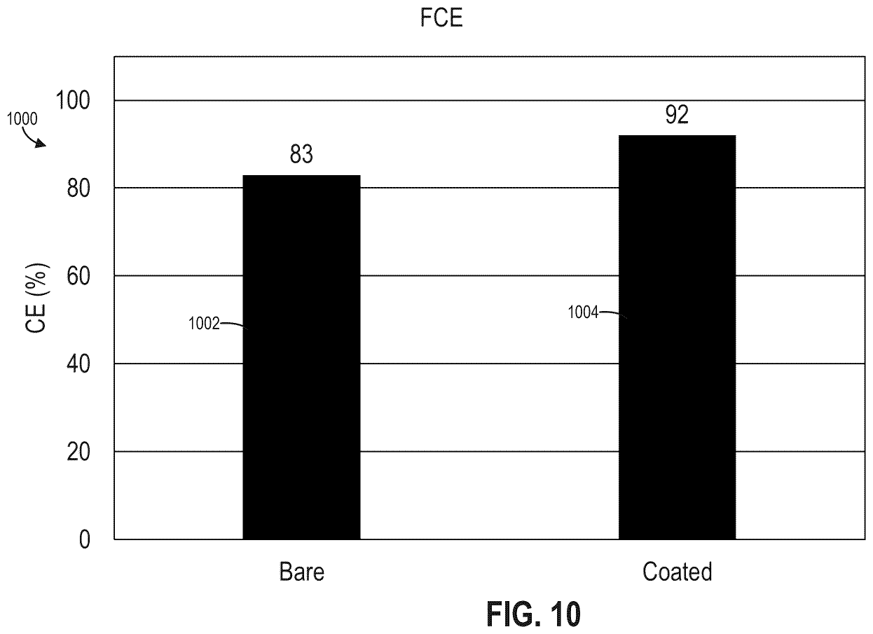

Turning now to FIG. 10, a chart 1000 is shown comparing a first cycle coulombic efficiency of the bare SS-LIB and the coated SS-LIB measured at charging and discharging rates of C/20. A first bar 1002 corresponds to the bare SS-LIB and a second bar 1004 corresponds to the coated SS-LIB. As shown in chart 1000, the coated SS-LIB has a higher first cycle coulombic efficiency than the bare SS-LIB. This is indicative of the increase in battery performance resulting from the beneficial nature of the LiNbO₃ coating in combination with carbon coating resulting in stabilizing the cathode/electrolyte interface without overly hindering transfer of electrons through the cathode. As shown by further comparisons of capacity retention at C/10, C/20, and C/40 the LiNbO₃ buffer coating stabilizes the cathode electrolyte interface both mechanically and chemically.

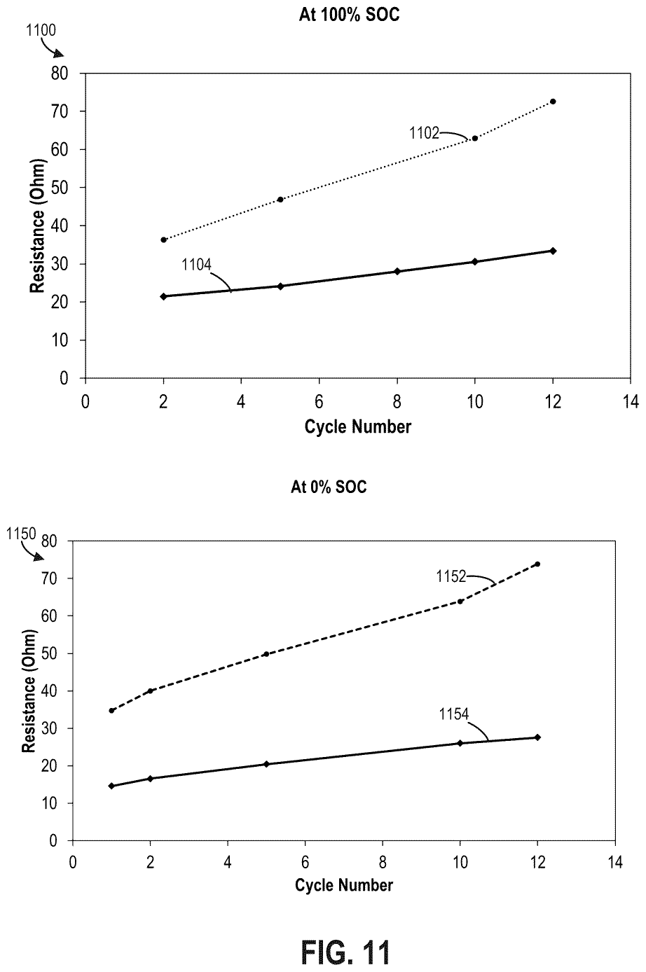

Turning now to FIG. 11, graphs of charge transfer resistance as a function of cycle number measured using electrochemical impedance spectroscopy (EIS) is shown. Two EIS spectra are collected for each cycle. A first spectrum is collected after charging to 3.8V (100% SOC) and a second spectrum is collected after discharging to 2.5V (0% SOC). A first graph 1100 corresponds to measurements performed at 100% state of charge (SOC) and a second graph 1150 corresponds to measurements performed at 0% SOC. Plots 1102 and 1152 corresponds to measurements of the bare SS-LIB and plots 1104 and 1154 correspond to measurements of the coated SS-LIB. As shown in FIG. 11, the coated SS-LIB has a lower charge transfer resistance than the bare SS-LIB. Over the course of repeated cycling the rate of increase in charge transfer resistance is faster for the bare SS-LIB than for the coated SS-LIB. In this way, it is shown that the LiNbO₃ buffer coating stabilizes the interface between the cathode material and the electrolyte.

The technical effect of the method is to form an all solid state battery including a low energy density cathode active material protected by a buffer layer coating. The buffer coating formed by the method described herein may result in low energy density cathode active material particles including both a buffer coating and a conductive coating. The conductive coating and buffer coating are formed to work synergistically to provide a cathode material layer for an all solid state lithium ion battery including sulfide based electrolyte, which shows increased capacity and cycling stability compared to a corresponding all solid state lithium ion battery prepared with bare cathode active material particles, which do not include the buffer layer.

The disclosure also provides support for a method of coating carbon coated lithium iron phosphate (LFP) particles for an all solid state lithium ion battery, comprising: obtaining carbon coated LFP particles, mixing the carbon coated LFP particles with an alkoxide precursor solution to form a mixture, hydrolyzing the mixture to form hydrolyzed carbon coated LFP particles, and heating the hydrolyzed carbon coated LFP particles to form an amorphous buffer coating on the carbon coated LFP particles. In a first example of the method, the alkoxide precursor solution includes a metal alkoxide precursor and the amorphous buffer coating is an amorphous lithium metal oxide. In a second example of the method, optionally including the first example, the alkoxide precursor solution includes niobium alkoxide and the amorphous buffer coating is amorphous LiNbO3. In a third example of the method, optionally including one or both of the first and second examples, heating the hydrolyzed carbon coated LFP particles preserves a carbon coating of the carbon coated LFP particles positioned between an LFP core of the carbon coated LFP particles and the amorphous buffer coating. In a fourth example of the method, optionally including one or more or each of the first through third examples, heating the hydrolyzed carbon coated LFP particles includes heating in a temperature below 250° C. In a fifth example of the method, optionally including one or more or each of the first through fourth examples, hydrolyzing the mixture includes adding water as a solution in solvent at a rate less than or equal to 5 mL/min. In a sixth example of the method, optionally including one or more or each of the first through fifth examples, the carbon coated LFP particles includes 1 to 2% carbon by weight.

The disclosure also provides support for a cathode of an all solid state lithium ion battery, comprising: a cathode sulfide based electrolyte, and cathode active material particles comprising a lithium iron phosphate (LFP) core, a carbon coating in face sharing contact with the LFP core and a LiNbO3 coating in face sharing contact with the carbon coating, wherein a thickness of the carbon coating and the LiNbO3 coating combined is in a range of from 5 nm to 100 nm and the carbon coating and the LiNbO3 coating combined comprise 0.5 wt % to 3 wt % of the cathode active material particles, and wherein between 5% to 15% of a surface area of the carbon coating is not in contact with the LiNbO3 coating. In a first example of the system, a thickness of the LiNbO3 coating is in a range of 5 nm to 60 nm. In a second example of the system, optionally including the first example, the LFP core is single crystalline. In a third example of the system, optionally including one or both of the first and second examples of the LFP core is in a range of 2 μm to 4 μm. In a fourth example of the system, optionally including one or more or each of the first through third examples, a weight percent of LiNbO3 in the cathode active material particles is in a range of 0.1% to 3%. In a fifth example of the system, optionally including one or more or each of the first through fourth examples, the cathode sulfide based electrolyte is one or more of Li6PS5Cl, Li7P3S11, Li5PS4ClBr, and Li3PS4. In a sixth example of the system, optionally including one or more or each of the first through fifth examples, a weight percent of cathode active material in the cathode is 70 wt. %. In a seventh example of the system, optionally including one or more or each of the first through sixth examples, a weight percent of the cathode sulfide based electrolyte in the cathode is 25 wt. %.

The disclosure also provides support for an all solid state lithium ion battery, comprising: an anode, a cathode, the cathode comprising a cathode sulfide based electrolyte, and cathode active material particles comprising a lithium iron phosphate (LFP) core, a carbon coating in face sharing contact with the LFP core and a LiNbO3 coating in face sharing contact with the carbon coating, wherein a thickness of the carbon coating and the LiNbO3 coating combined is in a range of from 5 nm to 100 nm, and the carbon coating and the LiNbO3 coating combined comprise 0.5 wt % to 3 wt % of the cathode active material particles, and wherein between 5% to 15% of a surface area of the carbon coating is not in contact with the LiNbO3 coating, and a separator sulfide based electrolyte positioned between the anode and cathode. In a first example of the system, the cathode further comprises binder and conductive carbon. In a second example of the system, optionally including the first example, the anode includes lithium metal. In a third example of the system, optionally including one or both of the first and second examples, a stack pressure is in a range of 0.5 MPa to 2 MPa. In a fourth example of the system, optionally including one or more or each of the first through third examples, a charge transfer resistance of the all solid state lithium ion battery is less than a corresponding all solid state lithium ion battery including bare cathode active material particles.

Various modifications of the present invention, in addition to those shown and described herein, will be apparent to those skilled in the art of the above description. Such modifications are also intended to fall within the scope of the appended claims. The foregoing description is illustrative of particular embodiments of the invention, but it is not meant to be a limitation upon the practice thereof. The foregoing discussion should be understood as illustrative and should not be considered limiting in any sense. While inventions have been particularly shown and described with references to preferred embodiments thereof, it will be understood by those skilled in the art that various changes in form and details may be made therein without departing from the spirit and scope of the inventions as defined by the claims. The corresponding structures, materials, acts and equivalents of all means or steps plus function elements in the claims below are intended to include any structure, material or acts for performing the functions in combination with other claimed elements as specifically claimed.

Finally, it will be understood that the articles, systems, and methods described hereinabove are embodiments of this disclosure—non-limiting examples for which numerous variations and extensions are contemplated as well. Accordingly, this disclosure includes all novel and non-obvious combinations and sub-combinations of the articles, systems, and methods disclosed herein, as well as any and all equivalents thereof.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method of coating carbon coated lithium iron phosphate (LFP) particles for an all solid state lithium ion battery, comprising:
obtaining carbon coated LFP particles;
mixing the carbon coated LFP particles with an alkoxide precursor solution to form a mixture;
hydrolyzing the mixture to form hydrolyzed carbon coated LFP particles; and
heating the hydrolyzed carbon coated LFP particles to form an amorphous buffer coating on the carbon coated LFP particles.

2. The method of claim 1, wherein the alkoxide precursor solution includes a metal alkoxide precursor and the amorphous buffer coating is an amorphous lithium metal oxide.

3. The method of claim 1, wherein the alkoxide precursor solution includes niobium alkoxide and the amorphous buffer coating is amorphous LiNbO₃.

4. The method of claim 1, wherein heating the hydrolyzed carbon coated LFP particles preserves a carbon coating of the carbon coated LFP particles positioned between an LFP core of the carbon coated LFP particles and the amorphous buffer coating.

5. The method of claim 1, wherein heating the hydrolyzed carbon coated LFP particles includes heating in a temperature below 250° C.

6. The method of claim 1, wherein hydrolyzing the mixture includes adding water as a solution in solvent at a rate less than or equal to 5 mL/min.

7. The method of claim 1, wherein the carbon coated LFP particles includes 1 to 2% carbon by weight.

8. A cathode of an all solid state lithium ion battery, comprising:
a cathode sulfide based electrolyte; and
cathode active material particles comprising a lithium iron phosphate (LFP) core, a carbon coating in face sharing contact with the LFP core and a LiNbO₃ coating in face sharing contact with the carbon coating, wherein a thickness of the carbon coating and the LiNbO₃ coating combined is in a range of from 5 nm to 100 nm and the carbon coating and the LiNbO₃ coating combined comprise 0.5 wt % to 3 wt % of the cathode active material particles, and wherein between 5% to 15% of a surface area of the carbon coating is not in contact with the LiNbO₃ coating.

9. The cathode of claim 8, wherein a thickness of the LiNbO₃ coating is in a range of 5 nm to 60 nm.

10. The cathode of claim 8, wherein the LFP core is single crystalline.

11. The cathode of claim 8, wherein a D50 of the LFP core is in a range of 2 μm to 4 μm.

12. The cathode of claim 8, wherein a weight percent of LiNbO₃ in the cathode active material particles is in a range of 0.1% to 3%.

13. The cathode of claim 8, wherein the cathode sulfide based electrolyte is one or more of Li₆PS₅Cl, Li₇P₃S₁₁, Li₅PS₄ClBr, and Li₃PS₄.

14. The cathode of claim 8, wherein a weight percent of cathode active material in the cathode is 70 wt. %.

15. The cathode of claim 8, wherein a weight percent of the cathode sulfide based electrolyte in the cathode is 25 wt. %.

16. An all solid state lithium ion battery, comprising:
an anode;
a cathode, the cathode comprising a cathode sulfide based electrolyte; and cathode active material particles comprising a lithium iron phosphate (LFP) core, a carbon coating in face sharing contact with the LFP core and a LiNbO₃ coating in face sharing contact with the carbon coating, wherein a thickness of the carbon coating and the LiNbO₃ coating combined is in a range of from 5 nm to 100 nm, and the carbon coating and the LiNbO₃ coating combined comprise 0.5 wt % to 3 wt % of the cathode active material particles, and wherein between 5% to 15% of a surface area of the carbon coating is not in contact with the LiNbO₃ coating; and
a separator sulfide based electrolyte positioned between the anode and cathode.

17. The all solid state lithium ion battery of claim 16, wherein the cathode further comprises binder and conductive carbon.

18. The all solid state lithium ion battery of claim 16, wherein the anode includes lithium metal.

19. The all solid state lithium ion battery of claim 16, wherein a stack pressure is in a range of 0.5 MPa to 2 MPa.

20. The all solid state lithium ion battery of claim 16, wherein a charge transfer resistance of the all solid state lithium ion battery is less than a corresponding all solid state lithium ion battery including bare cathode active material particles.
